(19) United States
(12) Patent Application Publication
(10) Pub. No.: US 2023/0169582 A1
(43) Pub. Date: Jun. 1, 2023

(54) POWER TRADING SYSTEM

(71) Applicant: TOYOTA JIDOSHA KABUSHIKI KAISHA, Toyota-shi (JP)

(72) Inventors: Hiromitsu KIGURE, Ashigarakami-gun (JP); Kazutaka KIMURA, Mishima-shi (JP); Kazuki OBATA, Susono-shi (JP); Yuki KUDO, Susono-shi (JP); Satoshi KIKUCHI, Hadano-shi (JP); Yuta MANIWA, Susono-shi (JP)

(21) Appl. No.: 17/938,696

(22) Filed: Oct. 7, 2022

(30) Foreign Application Priority Data
Nov. 26, 2021 (JP) 2021-192289

(51) Int. Cl. G06Q 30/08; G06Q 50/06

(52) U.S. Cl. CPC G06Q 30/08; G06Q 50/06

(57) ABSTRACT

A power trading system includes an alternative power storage device (power storage device and battery pallet) managed by an operator of a P2P power trading market. In a case where nonfulfillment trading occurs in which fulfillment of power trading is difficult, a trading alternative unit of a trading market server performs power trading (alternative trading) related to the nonfulfillment trading by using the alternative power storage device.

### CROSS-REFERENCE TO RELATED APPLICATION

This application claims priority to Japanese Patent Application No. 2021-192289 filed on Nov. 26, 2021, incorporated herein by reference in its entirety.

### BACKGROUND

### 1. Technical Field

The present disclosure relates to a power trading system.

### 2. Description of Related Art

Japanese Unexamined Patent Application Publication No. 2020-9334 (JP 2020-9334 A) discloses a power platform that manages power trading between members by a distributed ledger based on blockchain technology.

### SUMMARY

In recent years, due to the liberalization of power, as in JP 2020-9334 A, in a power trading market, the introduction of a peer to peer (P2P) power trading is considered in which a power sales trading between individuals or corporations having power resources with other individuals or corporations is directly performed. In the P2P power trading market, since the power trading is directly performed on a supply side and a demand side of the power, in a case where one of participants does not fulfill the contracted trading for some reason, a disadvantage or a loss is given to the other side. In a case where such nonfulfillment occurs frequently, the reliability of the P2P power trading market is decreased, and thus it is not preferable for promoting the use of the P2P power trading market.

The present disclosure is to suppress a decrease in the reliability of the P2P power trading market by enabling the transfer of the power even in a case where the nonfulfillment occurs in the power trading directly performed between the supply side and the demand side of the power.

An aspect of the present disclosure relates to a power trading system including a server configured to manage a power trading market in which power trading is directly performed between a supply side and a demand side of power, and an agent for a user who participates in the power trading market to perform a bid. The power trading system includes an alternative power storage device managed by an operator who operates the power trading market. The agent includes a power trading plan creation unit configured to create a power trading plan for performing the power trading through the power trading market, and a bid unit configured to perform a bid based on the power trading plan. The server includes a contract unit configured to aggregate the bids and perform contract for the power trading, and a trading alternative unit configured to, in a case where nonfulfillment trading occurs in which fulfillment of the contracted power trading is difficult, perform the power trading related to the nonfulfillment trading by using the alternative power storage device.

With this configuration, in a case where the bid for the power trading plan is performed by the agent, the server aggregates the bids and performs the contract for the power trading. In a case where the nonfulfillment trading occurs in which the fulfillment of the contracted power trading is difficult, the trading alternative unit of the server performs the power trading related to the nonfulfillment trading by using the alternative power storage device managed by the operator of the power trading market. Since the power can be transferred by using the alternative power storage device and the power trading related to the nonfulfillment trading can be performed even in a case where the nonfulfillment of the power trading occurs, even in a case where one of participants (users) does not fulfill the contracted trading for some reason, it is possible to avoid giving the disadvantage or the loss to the other side, and it is possible to suppress the decrease of the reliability of the P2P power trading market.

In the power trading system, the server may further include an evaluation value calculation unit configured to calculate an evaluation value of the user based on a fulfillment history of the user with respect to the contract, and the evaluation value calculation unit may be configured to calculate the evaluation value such that the evaluation value deteriorates in a case where the contracted power trading is not fulfilled.

With this configuration, the evaluation value calculation unit calculates the evaluation value such that the evaluation value of the user deteriorates in a case where the contracted power trading is not fulfilled. Since it can be expected that the user will endeavor to fulfill the power trading such that the evaluation value does not deteriorate, it can be expected that a frequency of the occurrence of the nonfulfillment of the power trading will be decreased.

In the power trading system, the trading alternative unit may be configured to perform the power trading related to the nonfulfillment trading of the user having a highest evaluation value among the users by using the alternative power storage device in a case where a plurality of pieces of the nonfulfillment trading occurs and there is competition for the power trading by using the alternative power storage device between the users.

With this configuration, in a case where there is a competition for the power trading by using the alternative power storage device, it is possible to prioritize the user having a high evaluation value and perform the power trading by using the alternative power storage device, and it can be expected that incentive (motivation) for the evaluation value will be increased.

In the power trading system, the alternative power storage device may be a vehicle on which a power storage device is mounted.

With this configuration, it is possible to dispatch the vehicle on which the power storage device is mounted to a power trading place in which the nonfulfillment trading occurs and perform the power trading related to the nonfulfillment trading.

In the power trading system, the power trading plan creation unit may be configured to create the power trading plan of an electrified vehicle, and the trading alternative unit may be configured to predict occurrence of the nonfulfillment trading based on positional information of the electrified vehicle.

With this configuration, the electrified vehicle can be utilized as a power resource, and the convenience is improved. On the other hand, it may be difficult for the electrified vehicle to reach the power trading place by a trading time (contracted charging or discharging time) due to traffic congestion or the like. The trading alternative unit can predict the occurrence of the nonfulfillment trading in which it is difficult for the electrified vehicle to reach the power trading place by the trading time based on the positional information of the electrified vehicle.

In the power trading system, the trading alternative unit may be configured to determine that the nonfulfillment trading occurs in a case where the user reports the nonfulfillment trading.

With this configuration, in a case where it is difficult for the user to fulfill the contracted power trading due to the circumstances of the user, it is possible to perform the power trading related to the nonfulfillment trading by utilizing the alternative power storage device.

In the power trading system, the trading alternative unit may be configured to perform the power trading related to the nonfulfillment trading by discharging the alternative power storage device of which an SOC is equal to or larger than a predetermined value, and perform the power trading related to the nonfulfillment trading by charging the alternative power storage device of which the SOC is less than the predetermined value.

With this configuration, since the power trading by using the alternative power storage device is performed such that the alternative power storage device is discharged in a case where the SOC of the alternative power storage device is large and the alternative power storage device is charged in a case where the SOC of the alternative power storage device is small, it is possible to effectively utilize the alternative power storage device and perform the power trading related to the nonfulfillment trading.

According to the present disclosure, it is possible to suppress the decrease in the reliability of the P2P power trading market by enabling the transfer of the power even in a case where the nonfulfillment occurs in the power trading directly performed between the supply side and the demand side of the power.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing an example of a power trading system according to an embodiment;

FIG. 2 is a diagram schematically showing an example of a P2P power trading market;

FIG. 3 is a diagram showing an example of a bid in a general trading market for the P2P power trading;

FIG. 4 is a diagram showing an example of a bid in a direct trading market for the P2P power trading;

FIG. 5 is a diagram showing an example of hardware configurations of an agent and a trading market server;

FIG. 6 is a table showing an example of resource information;

FIG. 7 is a table showing an example of agent information;

FIG. 8 is a block diagram functionally showing configurations of the agent and the trading market server; and

FIG. 9 is a flowchart showing a process of alternative trading control performed by a trading alternative unit.

### DETAILED DESCRIPTION OF EMBODIMENTS

In the following, an embodiment of the present disclosure will be described in detail with reference to the drawings. It should be noted that, in the drawings, the same or corresponding parts are designated by the same reference signs and the description thereof will not be repeated.

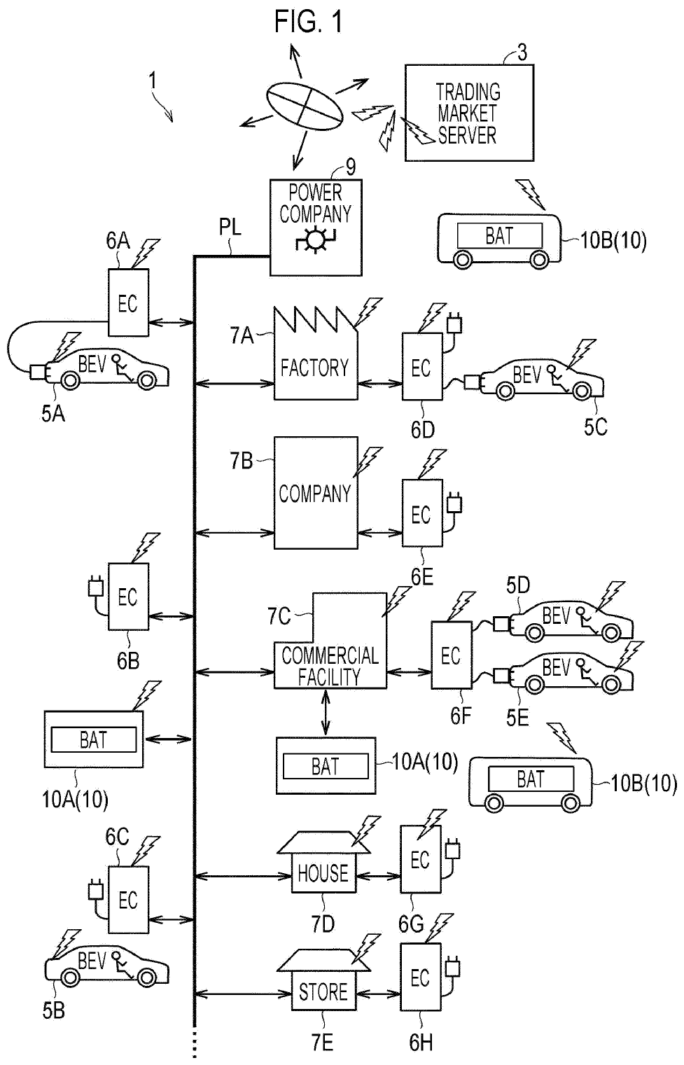

FIG. 1 is a diagram for describing an example of a power trading system 1 according to the embodiment. With reference to FIG. 1, the power trading system 1 includes a trading market server 3, electrified vehicles 5A to 5E, charging or discharging equipment 6A to 6H, a factory 7A, a company 7B, a commercial facility 7C, a house 7D, a store 7E, a power company 9, and a power transmission line network PL. The electrified vehicles 5A to 5E, the factory 7A, the company 7B, the commercial facility 7C, the house 7D, and the store 7E are power resources in the power trading system 1 and function as a so-called prosumer. Each power resource is configured to transfer power to and from other power resources through the power transmission line network PL or directly.

It should be noted that the number of electrified vehicles and the number of pieces of charging or discharging equipment are not limited to the numbers shown in FIG. 1. In addition, the facilities, such as the factory 7A, are not limited to those shown in FIG. 1. It should be noted that, in the following, each of the electrified vehicles 5A to 5E may be referred to as “electrified vehicle 5” without distinction, and each of the charging or discharging equipment 6A to 6H may be referred to as “charging or discharging equipment 6” without distinction. In addition, each of the factory 7A, the company 7B, the commercial facility 7C, the house 7D, and the store 7E may be referred to as “facility 7” without distinction.

The electrified vehicle 5 is an electrified vehicle that can travel by using the power stored in a battery. The electrified vehicle 5 is electrically connected to the charging or discharging equipment 6, and is configured to charge or discharge the battery through the charging or discharging equipment 6. The electrified vehicle 5 is, for example, a battery electric vehicle (BEV), and may be a plug-in hybrid electrical vehicle (PHEV) equipped with an internal combustion engine and a battery. The electrified vehicle 5 can be electrically connected to the charging or discharging equipment 6, and can transfer the power to and from the power transmission line network PL or the facility 7 through the charging or discharging equipment 6. It should be noted that the electrified vehicle 5 may be a fuel cell electric vehicle (FCEV) equipped with a battery capable of external charging.

The facility 7 is electrically connected to the power transmission line network PL and can transfer the power to and from the power transmission line network PL. In addition, the facility 7 is also electrically connected to the charging or discharging equipment 6, and can transfer the power to and from the electrified vehicle 5 connected to the charging or discharging equipment 6. The facility 7 is provided with a battery that stores the power, and is configured to charge or discharge the battery through the power transmission line network PL or the charging or discharging equipment 6. In addition, the facility 7 may be provided with a power generation facility, such as solar photovoltaics (PV).

The charging or discharging equipment 6 is electrically connected to the power transmission line network PL or the facility 7. The charging or discharging equipment 6 includes a power cable. The charging or discharging equipment 6 can be electrically connected to the electrified vehicle 5 through the power cable, and the electrified vehicle 5 can transfer the power to and from the power transmission line network PL or the facility 7 through the charging or discharging equipment 6 that is a connection destination.

The power company 9 manages a power plant (not shown). The power generated by the power plant can be supplied to each facility 7 through the power transmission line network PL (system power network), and can also be supplied to the electrified vehicle 5A connected to the charging or discharging equipment 6A to 6C.

In the related art, the power is supplied from the power plant of the power company 9 to the facility 7 or the electrified vehicle 5 through the power transmission line network PL. Due to the liberalization of the power and the spread of the power generation technology for renewable energy in recent years, without being limited to the power company 9, the power sales trading between individuals or corporations who have the power resources are considered. In the power trading system 1 according to the present embodiment, power sales trading between individuals or corporations (each facility 7 or each electrified vehicle 5), that is, peer to peer (P2P) power trading can be performed.

The trading market server 3 provides a platform for performing the P2P power trading. The trading market server 3 is configured to communicate with the electrified vehicle 5, the charging or discharging equipment 6, and the facility 7 through a communication network. A plurality of power trading markets is formed in the trading market server 3. In a case where the electrified vehicle 5 or the facility 7 desires the P2P power trading, the electrified vehicle 5 or the facility 7 (specifically, an agent (described below) that performs the power trading of the electrified vehicle 5 or the facility 7) designates the power trading market in which the power trading is to be performed, and performs a bid with respect to the trading market server 3 using, for example, a time zone when the power is to be sold, a power amount sold in each unit time zone, and a trading price as a bid condition. The trading market server 3 uses any algorithm to activate a power trading contract between a seller and a buyer who meet the bid condition, and processes a bid for which a partner who meets the condition cannot be found as a non-contract. It should be noted that the “bid” means the act of ordering the power trading (purchase or sale) or the order itself. The “contract” means the act of deciding to perform the bid for the power trading, or the decision itself. It should be noted that the trading market server 3 according to the present embodiment corresponds to an example of a “server” according to the present disclosure.

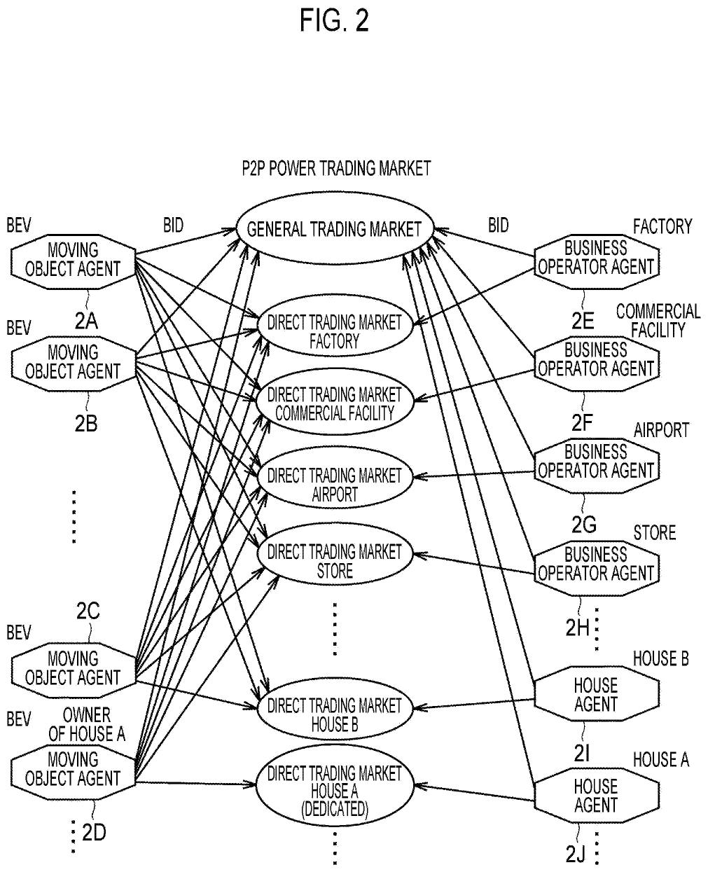

FIG. 2 is a diagram schematically showing an example of the P2P power trading market. With reference to FIG. 2, in the P2P power trading market, planning and performing the bid, managing the contract, creating a charging or discharging plan based on the contract, and the like are performed by the “agent” that performs the bid with respect to the P2P power trading market. The agent is provided for each electrified vehicle 5 or for each facility 7. In the present embodiment, a plurality of agents 2A to 2D corresponding to the electrified vehicle 5, a plurality of agents 2E to 2H corresponding to the factory 7A, and a plurality of agents 21 and 2G corresponding to the house are present. For example, in a case of the electrified vehicle 5, a moving body agent of the electrified vehicle 5 creates a power trading plan (bid plan) with respect to the P2P power trading market, and performs the bid with respect to the P2P power trading market (trading market server 3) from the moving body agent. In a case of the house 7D, a house agent of the house 7D creates a power trading plan (bid plan) with respect to the P2P power trading market, and performs the bid with respect to the P2P power trading market (trading market server 3) from the house agent. It should be noted that an owner or a manager of the electrified vehicle 5, a business operator, such as the factory or the commercial facility, an owner of the house, and the like are users who participate in the P2P power trading market.

It should be noted that, in the following, each of the agents 2A to 2J may be referred to as “agent 2” without distinction. The agent 2 is an “information processing device” that creates the power trading plan for a corresponding power resource (prosumer) to perform the power trading through the P2P power trading market.

In the P2P power trading market, the “general trading market” and the “direct trading market” are present. In the present embodiment, the general trading market and the direct trading market are formed in the trading market server 3. The general trading market is a market in which the trading of the power transmitted through the power transmission line network PL is handled, and an unspecified number of agents 2 can participate in the power trading. In the general trading market, the power trading contract is performed in accordance with any rules set by an operator who operates the P2P power trading market (matching). As a matching rule, for example, there is a method of closing the trading on a first-come-first-served basis in a case where an asking price of the seller and an asking price of the buyer match in a predetermined unit time zone. As another matching rule, a method of closing the trading at an appropriate price after arranging the bids (orders) of the seller and the buyer performed in the unit time zone once.

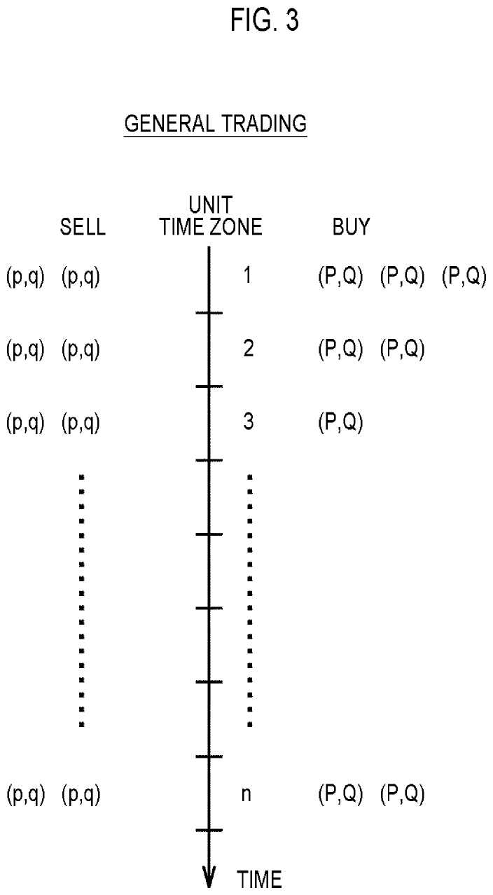

FIG. 3 is a diagram showing an example of the bid in the general trading market for the P2P power trading. With reference to FIG. 3, in the general trading market, for each predetermined unit time zone (1, 2, . . . , n), an unspecified number of buyers bid for a set (P, Q) of a purchase price and the power amount while an unspecified number of sellers bid for a set (p, q) of a sell price and the power amount. It should be noted that the unit time zone is a time width (for example, 30 minutes) set in the general trading market. The trading of the power amount is performed for each power amount (power x unit time zone length) transmitted in the unit time zone.

With reference to FIG. 2 again, the direct trading market is a market in which the electrified vehicle 5 moves to the place of the facility 7 and handles the trading of the power transmitted without going through the power transmission line network PL, and solely the agent having an ID of the direct trading market can participate in the power trading. In the direct trading market, one market is formed for the facility 7 in which the charging or discharging equipment 6 is installed. In the direct trading market, for example, the power trading contract is performed in accordance with any rules set by the operator who operates the P2P power trading market for each direct trading market (matching). As the matching rule, the method described in the general trading market can be adopted. It should be noted that, in the present embodiment, the trading market server 3 manages the general trading market and the direct trading market in accordance with the matching rules for each P2P power trading market (general trading market and direct trading market), but a server corresponding to the trading market server 3 may be provided for each P2P power trading market.

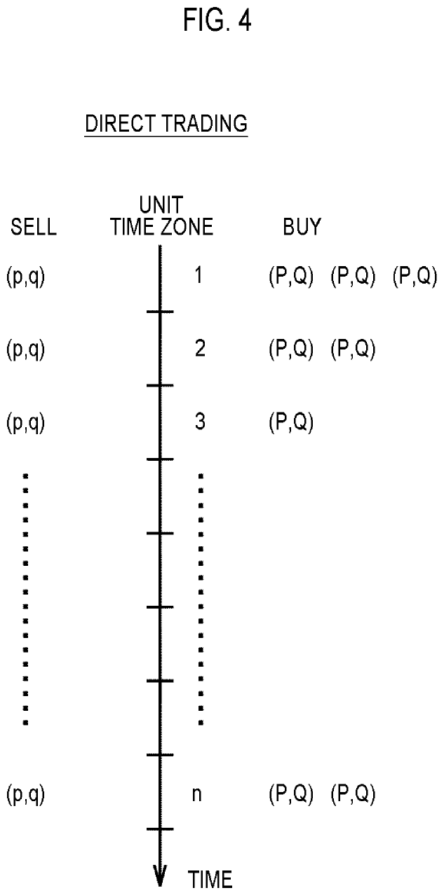

FIG. 4 is a diagram showing an example of the bid in the direct trading market for the P2P power trading. With reference to FIG. 4, in the direct trading market, for each predetermined unit time zone (1, 2, . . . , n), a plurality of buyers having the IDs of the direct trading market bid for the set (P, Q) of a purchase price and the power amount with respect to the seller presenting the set (p, q) of the sell price and the power amount. The unit time zone is a time width set individually in the direct trading market. The trading of the power amount is performed for each power amount (power x unit time zone length) transmitted in the unit time zone.

With reference to FIG. 1 again, the power trading system 1 includes a plurality of power storage devices 10A and a plurality of battery pallets 10B managed by the operator of the P2P power trading market. The power storage device 10A may be a secondary battery that can be charged or discharged, and may be, for example, a lithium ion battery, a nickel hydrogen battery, or a NAS battery (sodium-sulfur battery). For example, the power storage device 10A is installed on a site of the commercial facility 7C, and transfers the power with electrical equipment on the premises of the commercial facility 7C. The power storage devices 10A may be installed on the site of the commercial facility 7C. In addition to the commercial facility 7C, the power storage devices 10A may be installed on the site of the facility 7, such as the company 7B or the store 7E. In addition, the power storage device 10A is also installed in the power transmission line network PL, and it is possible to transfer the power transmitted through the power transmission line network PL.

The battery pallet 10B is a vehicle on which a power storage device (for example, lithium ion battery) is mounted. The battery pallet 10B is managed by the operator of the P2P power trading market, moves to a place in which the power trading is performed, and transfers the power between the battery pallet 10B and the charging or discharging equipment 6 or the electrified vehicle 5. In the following, the power storage device 10A and the battery pallet 10B managed by the operator of the P2P power trading market may be referred to as “alternative power storage device 10” without distinction.

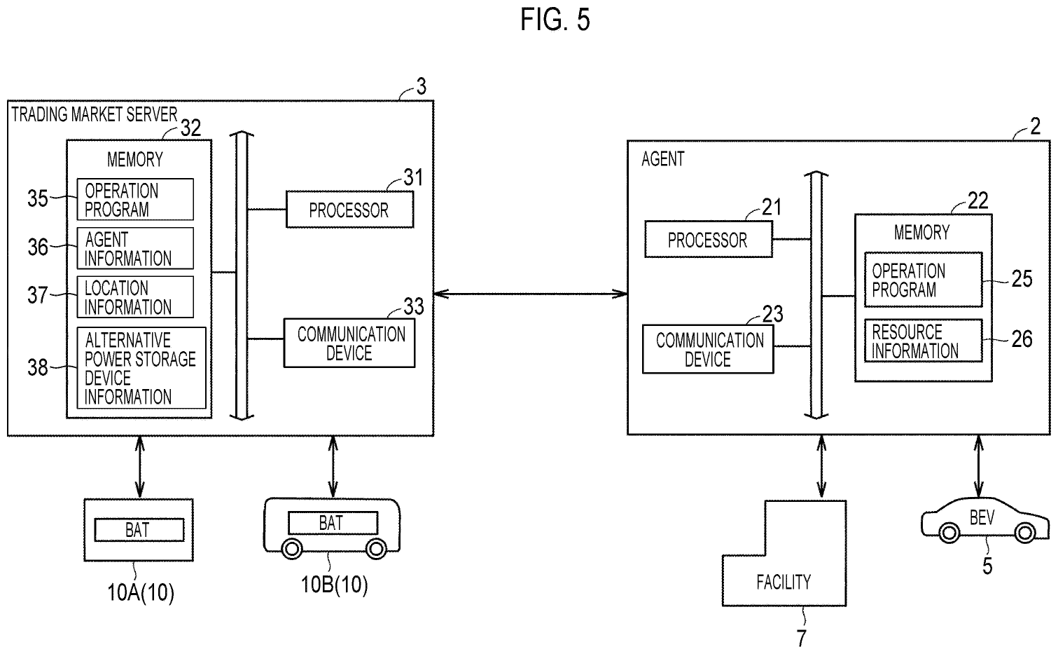

FIG. 5 is a diagram showing an example of hardware configurations of the agent 2 and the trading market server 3. With reference to FIG. 5, the agent 2 includes a processor 21, a memory 22, and a communication device 23. The agent 2 is provided for each facility 7 or each electrified vehicle 5 (prosumer). The agent 2 may be provided in a corresponding prosumer or may be provided in a cloud capable of communicating with the corresponding prosumer. In addition, the agent 2 may be composed of a mobile terminal connected to the corresponding prosumer by short-range wireless communication (Wi-Fi, Bluetooth, or the like).

The processor 21 is an operation unit (computer) that performs various processes by performing various programs. The processor 21 is composed of a central processing unit (CPU), a field-programmable gate array (FPGA), a graphics processing unit (GPU), and the like. The processor 21 may be composed of a processing circuitry.

The memory 22 stores programs and data for the processor 21 to perform various processes. The memory 22 is composed of a storage medium, such as a read only memory (ROM) and a random access memory (RAM). The memory 22 stores an operation program 25 and resource information 26.

The operation program 25 specifies the process performed by the processor 21. For example, the operation program 25 includes a program for performing the bid for the power trading in the P2P power trading market managed by the trading market server 3 with respect to the trading market server 3.

The resource information 26 includes information on the power resource (prosumer) corresponding to the agent 2, and particularly includes information on the bid and the contract for the power trading.

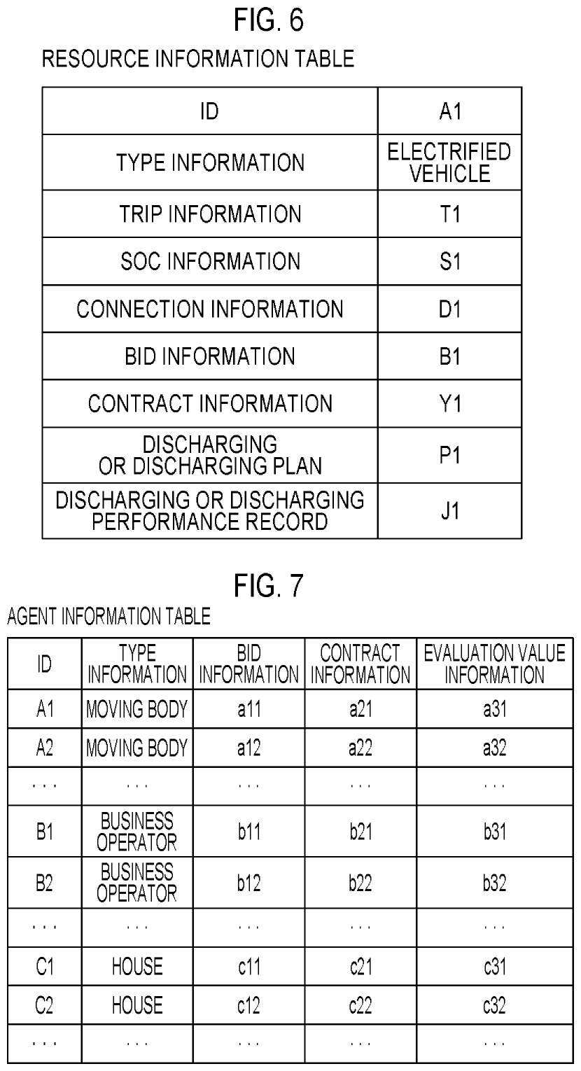

FIG. 6 is a table showing an example of the resource information 26. In FIG. 6, the resource information 26 in the agent 2 of the electrified vehicle 5 is shown. With reference to FIG. 6, the resource information 26 includes an ID, type information, trip information, state of charge (SOC) information, connection information, bid information, contract information, a charging or discharging plan, and a charging or discharging performance record.

The ID includes identification information for specifying the electrified vehicle 5. The type information includes information on a type of the power resource. The information on the type of the power resource includes, for example, information for specifying the electrified vehicle, the business operator, and the house. Since FIG. 6 shows an example of the agent 2, the type information includes information for specifying the electrified vehicle. For example, the type information of the resource information held by the agent 2 corresponding to the facility 7 includes, for example, information for specifying the business operator or the house. The trip information includes information on a travel history, such as a current travel plan, a past travel route, and a travel time. The SOC information includes information on the power amount (storage amount) currently stored in the battery. The connection information includes information for specifying whether or not the electrified vehicle 5 is currently connected to the charging or discharging equipment 6. The bid information includes information on a past bid history and information on a currently performed bid. The contract information includes information on a past contract history and information for specifying whether or not the currently performed bid is contracted. The charging or discharging plan includes information on the charging or discharging plan of the power resource based on the contract. The charging or discharging performance record includes information on a charging or discharging result with respect to the charging or discharging plan described above.

It should be noted that the trip information is replaced with history information in the agent 2 of the facility 7 (factory 7A, house 7D, or the like). The history information includes information on a past usage history of the power in the facility 7. The information on the usage history may be divided by a day of the week and the time zone, for example. In addition, the connection information is information used by the agent 2 of the electrified vehicle 5, and is blank in the agent 2 of the facility 7.

With reference to FIG. 5 again, the communication device 23 transmits and receives various data to and from the trading market server 3 through the communication network. In addition, the agent 2 (moving body agent) corresponding to the electrified vehicle 5 transmits the current position (positional information) of the electrified vehicle 5 to the trading market server 3.

The trading market server 3 includes a processor 31, a memory 32, and a communication device 33. The trading market server 3 is a device that manages the P2P power trading between the power resources in the P2P power trading market (general trading market and direct trading market), and performs a process related to the power trading.

The processor 31 is an operation unit (computer) that performs various processes by performing various programs. The processor 31 is composed of a CPU, an FPGA, a GPU, and the like. The processor 31 may be composed of a processing circuitry.

The memory 32 stores programs and data for the processor 31 to perform various processes. The memory 32 is composed of a storage medium, such as a ROM and a RAM. The memory 32 stores an operation program 35, agent information 36, location information 37, and alternative power storage device information 38.

The operation program 35 specifies the process performed by the processor 31. For example, the operation program 35 includes a program for performing a bid process of receiving the bids from the agents 2 and a contract process based on the bids. The contract process is a process of activating the power trading contract between the seller and the buyer who meet the bid condition, and processes the bid for which the partner who meets the condition cannot be found as the non-contract.

The agent information 36 includes information on the agent 2 participating in the P2P power trading market managed by the trading market server 3, and particularly includes information on the bid and the contract for the power trading for each agent 2.

FIG. 7 is a table showing an example of the agent information 36. With reference to FIG. 7, the agent information 36 includes an ID, type information, bid information, contract information, and evaluation value information.

The ID includes identification information for specifying the agent 2 participating in the P2P power trading market managed by the trading market server 3. The type information includes information on the type of the power resource, and includes, for example, the information for specifying the electrified vehicle, the business operator, and the house. The bid information includes information on a past bid history of each agent 2 and information on the currently performed bid. The contract information includes information on a past contract history of each agent 2 and information for specifying whether or not the currently performed bid is contracted. The past contract history includes a fulfillment history of the contract. The bid information and the contract information are updated each time the bid, the contract, and the fulfillment/nonfulfillment of the trading are performed in each agent 2. The evaluation value information is information on the evaluation value in the agent 2, and is the evaluation value related to the user. Details of the evaluation value will be described below.

With reference to FIG. 5 again, the location information 37 includes information on a place in which the contract in the direct trading market is performed. The place in which the contract is performed is the location of the facility 7 corresponding to the direct trading market. For example, the information on the places in which the contracts of the factory 7A, the company 7B, the house 7D, and the store 7E are performed includes the information on the locations of the factory 7A, the company 7B, the house 7D, and the store 7E, respectively.

The alternative power storage device information 38 includes information on the SOC of the power storage device 10A and the battery pallet 10B, an installation place of the power storage device 10A, and a current position of the battery pallet 10B.

The communication device 33 transmits and receives various data to and from the agent 2 through the communication network. In addition, the communication is performed with the alternative power storage device 10.

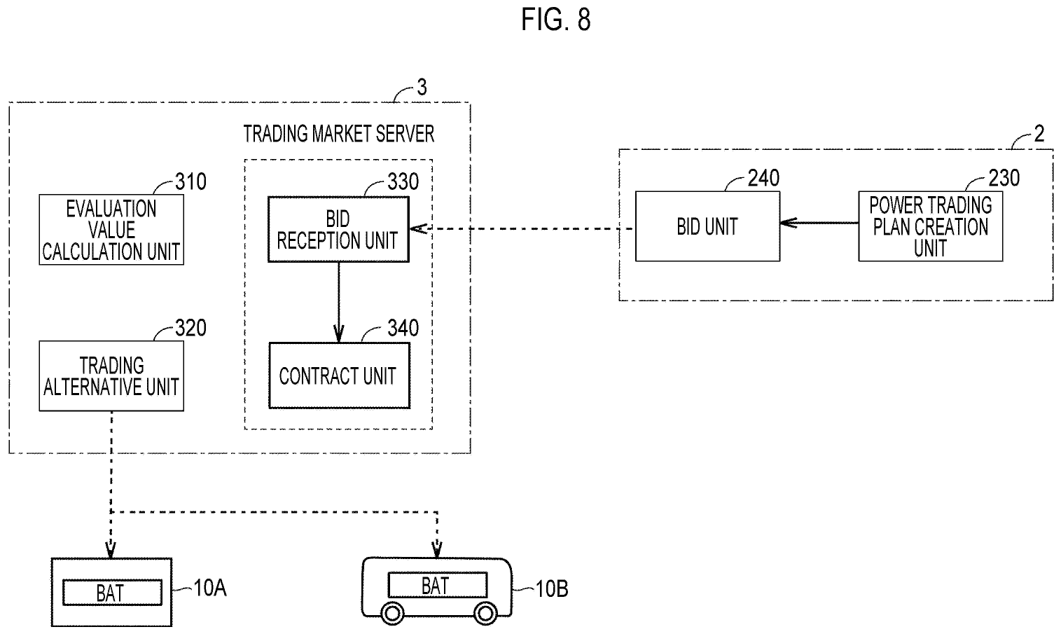

FIG. 8 is a block diagram functionally showing configurations of the agent 2 and the trading market server 3. The agent 2 includes a power trading plan creation unit 230 and a bid unit 240. The processor 21 functions as the power trading plan creation unit 230 and the bid unit 240, for example, by performing the operation program 25 stored in the memory 22. It should be noted that the power trading plan creation unit 230 and the bid unit 240 may be realized by, for example, dedicated hardware (electronic circuit).

The power trading plan creation unit 230 creates the power trading plan (charging or discharging plan). In a case where the agent 2 is the moving body agent corresponding to the electrified vehicle 5, the power trading plan creation unit 230 predicts a distance and a time that are increase when the electrified vehicle 5 passes through the location of the commercial facility 7C or a predetermined place, for example, by using a route to a destination of the electrified vehicle 5 and the place in which the contract is performed (location of the commercial facility 7C). The power trading plan creation unit 230 predicts power consumption needed to reach the destination by taking the increase into consideration. Moreover, the power trading plan creation unit 230 determines whether to perform a buy bid or a sell bid based on the predicted value of the power consumption and the current SOC (storage amount) of the electrified vehicle 5. Moreover, the power trading plan creation unit 230 creates the power trading plan that is optimal in terms of cost based on the trading price preset by the user or the predicted trading price of the market.

In a case where the agent 2 is the house agent corresponding to the house, the power trading plan creation unit 230 determines whether to perform the buy bid or the sell bid from a current season, expected sunshine duration (PV power generation amount), a power consumption performance record, the charging or discharging performance record, and the like, and creates the power trading plan that is optimal in terms of cost based on the trading price preset by the user or the predicted trading price of the market. The power trading plan creation unit 230 outputs the power trading plan to the bid unit 240.

The bid unit 240 performs the bid based on the power trading plan to the trading market server 3. Further, the bid unit 240 transmits information on the electrified vehicle 5 to the trading market server 3 together with the bid described above. The information on the electrified vehicle 5 includes, for example, the trip information included in the resource information 26 and the current position of the electrified vehicle 5.

The trading market server 3 includes an evaluation value calculation unit 310, a trading alternative unit 320, a bid reception unit 330, and a contract unit 340. The processor 31 functions as the evaluation value calculation unit 310, the trading alternative unit 320, the bid reception unit 330, and the contract unit 340 by performing, for example, the operation program 35 stored in the memory 32. It should be noted that the evaluation value calculation unit 310, the trading alternative unit 320, the bid reception unit 330, and the contract unit 340 may be realized by, for example, dedicated hardware (electronic circuit).

The bid reception unit 330 and the contract unit 340 function as the trading platform. The bid reception unit 330 receives the bids from the agent 2. The contract unit 340 aggregates the bids received by the bid reception unit 330, and performs the contract for the power trading in accordance with the rules of the general trading market or the rules of the direct trading market.

In a case where the contract for the power trading is performed by the contract unit 340, the electrified vehicle 5 and the facility 7 fulfill the power trading in accordance with a content of the contracted power trading (power trading plan). However, there is a possibility that the fulfillment of the contracted power trading is difficult due to because it is difficult for the electrified vehicle 5 to reach the place in which the contract is performed due to the traffic congestion or the like, or an abnormality occurs in electrical equipment of the facility 7. The trading in which the fulfillment of the contracted power trading is difficult is also called “nonfulfillment trading”. In a case where the nonfulfillment trading occurs, the disadvantage or the loss occurs for the user participating in the P2P power trading market, the reliability of the P2P power trading market is decreased, and thus it is not preferable for promoting the use of the P2P power trading market. In the present embodiment, even in a case where the nonfulfillment trading occurs, by enabling the transfer of the power related to the nonfulfillment trading using the alternative power storage device 10, the disadvantage or the loss for the user is suppressed, and the decrease in the reliability of the P2P power trading market is suppressed.

With reference to FIG. 8, the evaluation value calculation unit 310 of the trading market server 3 calculates the evaluation value of the user based on the fulfillment history with respect to the contract. The calculated evaluation value is stored in the evaluation value information of the agent information 36. The evaluation value may be represented as a numerical value (point), or may be ranked. In the present embodiment, the evaluation value is represented by the point, and the evaluation is higher (evaluation value is better) as the point is higher, and the evaluation is lower (evaluation value is worse) as the point is lower.

In a case where the contracted power trading is not fulfilled, the evaluation value calculation unit 310 performs point down of subtracting a predetermined point from the point of the user (agent 2) who causes the nonfulfillment. In addition, the evaluation value calculation unit 310 performs the point down of subtracting a first point smaller than the predetermined point from the point of the user (agent 2) who causes alternative trading described below. In this case, in a case where the user (agent 2) who causes the nonfulfillment reports the nonfulfillment trading, the point down may not be performed with respect to the evaluation value of the user, or a second point smaller than the first point may be subtracted.

In a case where the contracted power trading is fulfilled, the evaluation value calculation unit 310 performs point up of adding a certain point to the points of both users (agents 2) who perform the power trading. It should be noted that, in a case where the point up is performed, when the power trading is fulfilled, but there is a discrepancy with the contracted trading content (for example, the contracted time is delayed, and the charging or discharging amount is insufficient), the point to be added to the user (agent 2) who causes the discrepancy may be set to a value smaller than the certain point. The evaluation value calculation unit 310 calculates the evaluation value based on a fulfillment result of the power trading each time the fulfillment history included in the contract information of the agent information 36 is updated.

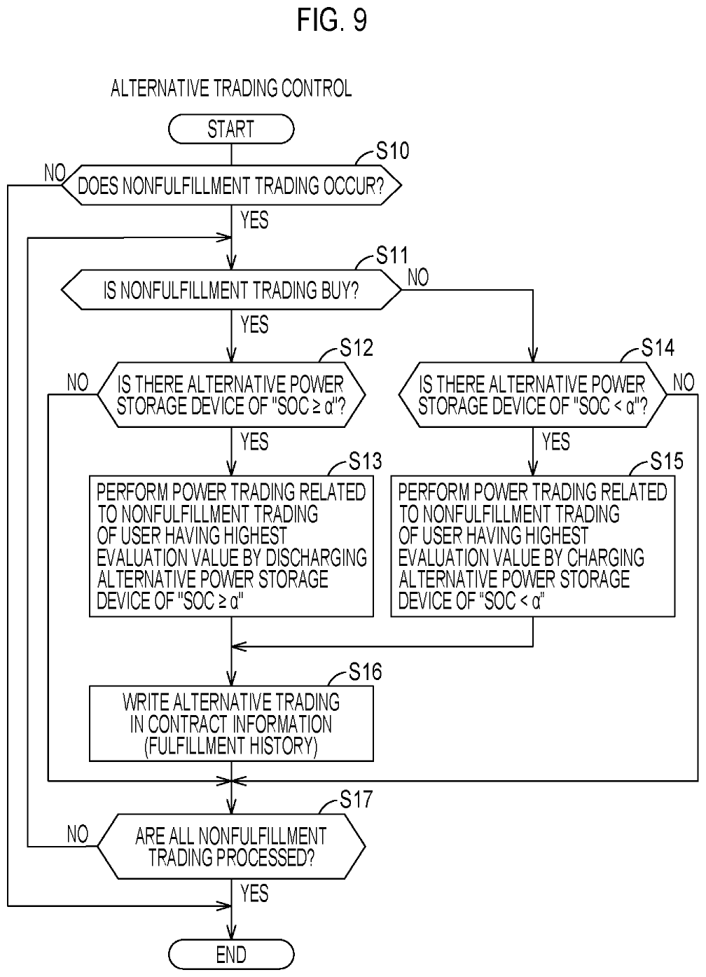

In a case where the nonfulfillment trading occurs, the trading alternative unit 320 performs the power trading related to the nonfulfillment trading by using the alternative power storage device 10. It should be noted that performing the power trading related to the nonfulfillment trading by using the alternative power storage device 10 is also referred to as “alternative trading”. FIG. 9 is a flowchart showing a process of alternative trading control performed by the trading alternative unit 320. The flowchart is interrupted at predetermined timings on the trading market server 3. In step (hereinafter, step is abbreviated as “S”) 10, the trading alternative unit 320 determines whether or not the nonfulfillment trading occurs. For example, in the power trading in which the electrified vehicle 5 participates, the trading alternative unit 320 determines that the nonfulfillment trading occurs in a case where an estimation is made that it is difficult for the electrified vehicle 5 to reach the contracted trading place by the contracted time from the current position (positional information) received from the agent 2 of the electrified vehicle 5. In a case where information indicating that the abnormality occurs in the electrical equipment of the facility 7 is received from the agent 2, the trading alternative unit 320 may determine that the nonfulfillment trading occurs. In addition, in a case where the user who participates in the P2P power trading market reports that it is difficult for the user to fulfill the contracted power trading by using agent 2 (in a case where there is a report of the nonfulfillment trading), the trading alternative unit 320 may determine that the nonfulfillment trading occurs.

In S10, in a case where the trading alternative unit 320 determines that the nonfulfillment trading occurs, the process proceeds to S11, and in a case where the trading alternative unit 320 determines that the nonfulfillment trading does not occur, the interrupt process this time is terminated.

In S11, a determination is made whether or not the nonfulfillment trading is “sell” trading. In the present embodiment, in a case where the power trading is difficult due to a cause on the sell bid side (in a case where the power supply (discharging) cannot be performed), a determination is made that the nonfulfillment trading is “sell” trading. In addition, in a case where the power trading is difficult due to a cause on the buy bid side (in a case where the power demand (charging) cannot be performed), a determination is made that the nonfulfillment trading is “buy” trading.

In a case where a determination is made in Si 1 that the nonfulfillment trading is “sell”, the process proceeds to S12, and the presence or absence of the alternative power storage device 10 (power storage device 10A and battery pallet 10B) of which the SOC is equal to or larger than a predetermined value a is determined (it should be noted that the alternative power storage device 10 that has already been allocated to the alternative trading is excluded from a determination target). The predetermined value a may be 50%, for example. In a case where there is the battery pallet 10B of which the SOC is equal to or larger than the predetermined value a, a positive determination is made in S12. In a case where the power storage device 10A is installed in the direct trading market in which the nonfulfillment trading occurs, when the SOC of the power storage device 10A is equal to or larger than the predetermined value a, a positive determination is made in S12. In addition, in a case where the nonfulfillment trading occurs in the general trading market, when the SOC of the power storage device 10A installed in the power transmission line network PL is equal to or larger than the predetermined value a, a positive determination is made in S12. In a case where a positive determination is made in S12, the process proceeds to S13, and in a case where a positive determination is not made (negative determination is made) in S12, the process proceeds to S17.

In S13, the evaluation value of the user who contracts the nonfulfillment trading this time is extracted from the evaluation value information of the agent information 36 (it should be noted that the evaluation value of the user who contracts the nonfulfillment trading that has already been a target of the alternative trading is excluded). Moreover, the power trading contracted by the user having the highest evaluation value is performed by discharging the alternative power storage device 10 (power storage device 10A and battery pallet 10B) of which the SOC is equal to or larger than the predetermined value. In this case, in a case where the power storage device 10A is installed in the direct trading market in which the nonfulfillment trading occurs, the power trading (alternative trading) is performed with respect to the nonfulfillment trading of the user having the highest evaluation value among the users who participate in the direct trading market by discharging the power storage device 10A. In a case where the power storage device 10A is not installed in the direct trading market in which the nonfulfillment trading occurs, the battery pallet 10B is dispatched to the place (facility 7) in which the nonfulfillment trading of the user having the highest evaluation value is performed, and the power trading (alternative trading) is performed by discharging the battery pallet 10B. In addition, in a case where the nonfulfillment trading occurs in the general trading market, the power trading (alternative trading) is performed with respect to the nonfulfillment trading of the user having the highest evaluation value among the users who participate in the general trading market by discharging the power storage device 10A through the power transmission line network PL. It should be noted that, in a case where the contracted trading power amount is larger than a dischargeable power amount of the alternative power storage device 10, discharging is performed to a lower limit SOC of the alternative power storage device 10, and the alternative trading is terminated.

In a case where a determination is not made in S11 that the nonfulfillment trading is “sell”, that is, in a case where the nonfulfillment trading is “buy”, the process proceeds to S14, and the presence or absence of the alternative power storage device 10 (power storage device 10A and battery pallet 10B) of which the SOC is less than the predetermined value a is determined (it should be noted that the alternative power storage device 10 that has already been allocated to the alternative trading is excluded from a determination target). In a case where there is the battery pallet 10B of which the SOC is less than the predetermined value a, a positive determination is made in S14. In a case where the power storage device 10A is installed in the direct trading market in which the nonfulfillment trading occurs, when the SOC of the power storage device 10A is less than the predetermined value a, a positive determination is made in S14. In addition, in a case where the nonfulfillment trading occurs in the general trading market, when the SOC of the power storage device 10A installed in the power transmission line network PL is less than the predetermined value a, a positive determination is made in S14. In a case where a positive determination is made in S14, the process proceeds to S15, and in a case where a positive determination is not made (negative determination is made) in S15, the process proceeds to S17.

In S14, the evaluation value of the user who contracts the nonfulfillment trading this time is extracted from the evaluation value information of the agent information 36 (it should be noted that the evaluation value of the user who contracts the nonfulfillment trading that has already been a target of the alternative trading is excluded). Moreover, the power trading contracted by the user having the highest evaluation value is performed by charging the alternative power storage device 10 (power storage device 10A and battery pallet 10B) of which the SOC is less than the predetermined value. In this case, in a case where the power storage device 10A is installed in the direct trading market in which the nonfulfillment trading occurs, the power trading (alternative trading) is performed with respect to the nonfulfillment trading of the user having the highest evaluation value among the users who participate in the direct trading market by charging the power storage device 10A. In a case where the power storage device 10A is not installed in the direct trading market in which the nonfulfillment trading occurs, the battery pallet 10B is dispatched to the place (facility 7) in which the nonfulfillment trading of the user having the highest evaluation value is performed, and the power trading (alternative trading) is performed by charging the battery pallet 10B. In addition, in a case where the nonfulfillment trading occurs in the general trading market, the power trading (alternative trading) is performed with respect to the nonfulfillment trading of the user having the highest evaluation value among the users who participate in the general trading market by charging the power storage device 10A through the power transmission line network PL. It should be noted that, in a case where the contracted trading power amount is larger than a chargeable power amount of the alternative power storage device 10, charging is performed to an upper limit SOC of the alternative power storage device 10, and the alternative trading is terminated.

After S13 and S15 are processed, the process proceeds to S16, the information on the alternative trading is written in the contract information (fulfillment history) of the agent information 36, and the process proceeds to S17. It should be noted that the information on the alternative trading is written solely to the user (agent 2) who causes the alternative trading. As a result, the evaluation value calculation unit 310 performs the point down with respect to the user (agent 2) who causes the alternative trading.

In S17, a determination is made whether or not the processes of S11 to S16 are terminated for all pieces of the nonfulfillment trading determined in S10. In a case where the processes of S11 to S16 are not terminated for all pieces of the nonfulfillment trading, the process returns to S11 and the processes of S11 to S16 are performed for unprocessed nonfulfillment trading. In a case where the process for all pieces of the nonfulfillment trading is terminated, the interrupt process this time is terminated. It should be noted that, in a case where an occurrence number of nonfulfillment trading exceeds the number of alternative power storage devices 10 (power storage device 10A and battery pallet 10B) that can be used for the alternative trading, a negative determination is made in S12 or S14, and the alternative trading is not performed with respect to the nonfulfillment trading.

In the present embodiment, in a case where the nonfulfillment trading occurs in which the fulfillment of the contracted power trading is difficult, the trading alternative unit 320 performs the “alternative trading” in which the power trading related to the nonfulfillment trading is performed by using the alternative power storage device 10 managed by the operator of the P2P power trading market. Therefore, since the power can be transferred by using the alternative power storage device 10 and the power trading related to the nonfulfillment trading can be performed even in a case where the nonfulfillment of the power trading occurs, even in a case where one of participants (users) does not fulfill the contracted trading for some reason, it is possible to avoid giving disadvantage or the loss to the other side, and it is possible to suppress the decrease of the reliability of the P2P power trading market.

In the present embodiment, the evaluation value calculation unit 310 calculates the evaluation value such that the user who complies with the contracted power trading has a higher evaluation, and the user who does not comply with the contracted power trading has a lower evaluation value. Moreover, in a case where the nonfulfillment trading occurs, the alternative trading is performed with respect to the power trading contracted by the user having the highest evaluation value among the users who contract the nonfulfillment trading. Therefore, it can be expected that the user will endeavor to fulfill the power trading such that the evaluation value does not deteriorate, it can be expected that a frequency of the occurrence of the nonfulfillment of the power trading will be decreased. In addition, in a case where a plurality of pieces of the nonfulfillment trading occurs and there is a competition for the power trading (alternative trading) using the alternative power storage device 10, since the alternative trading is performed with respect to the nonfulfillment trading of the user having the highest evaluation value, it can be expected that incentive (motivation) for the evaluation value will be increased.

In the present embodiment, the agent 2 (moving body agent) corresponding to the electrified vehicle 5 creates the power trading plan of the electrified vehicle 5 by the power trading plan creation unit 230 and performs the bid. Moreover, the trading market server 3 predicts the occurrence of the nonfulfillment trading based on the positional information of the electrified vehicle 5 by the trading alternative unit 320. The electrified vehicle 5 can be utilized as the power resource, and the convenience is improved. On the other hand, it may be difficult for the electrified vehicle 5 to reach the power trading place by a trading time (charging or discharging time) due to traffic congestion or the like, but the trading alternative unit 320 predicts the occurrence of the nonfulfillment trading in which it is difficult for the electrified vehicle 5 to reach the power trading place by the trading time (charging or discharging time) based on the positional information of the electrified vehicle 5, and performs the alternative trading, so that it is possible to suppress the decrease in the reliability of the P2P power trading market.

In the present embodiment, the trading alternative unit 320 determines that the nonfulfillment trading occurs in a case where the user reports the nonfulfillment trading. Moreover, in a case where the user reports the nonfulfillment trading, the evaluation value calculation unit 310 calculates the evaluation value such that the point down is not performed with respect to the evaluation value of the user or the point down is small, so that it can be expected that the user will positively report the nonfulfillment trading. As a result, in a case where the fulfillment of the contracted power trading is difficult due to the circumstances of the user, it can be expected that the alternative trading will be surely performed.

In the present embodiment, the trading alternative unit 320 performs the power trading (alternative trading) related to the nonfulfillment trading by discharging the alternative power storage device 10 of which the SOC is equal to or larger than the predetermined value a, and performs the alternative trading by charging the alternative power storage device 10 of which the SOC is less than the predetermined value a. Therefore, since the alternative trading is performed such that the alternative power storage device 10 is discharged in a case where the SOC of the alternative power storage device 10 is large and the alternative power storage device 10 is charged in a case where the SOC of the alternative power storage device 10 is small, it is possible to effectively utilize the alternative power storage device 10 and perform the power trading related to the nonfulfillment trading.

As the users who contract the nonfulfillment trading, there are the “user who causes the nonfulfillment trading (user who has a cause that makes the fulfillment of the power trading difficult)”, and the “user who has the disadvantage due to the nonfulfillment trading (user who can fulfill the power trading)”. In the embodiment described above, in S13 and S15, the evaluation value of the user who contracts the nonfulfillment trading is extracted from the evaluation value information of the agent information 36, the alternative trading is performed with respect to the power trading contracted by the user having the highest evaluation value, and the alternative trading is performed with respect to the nonfulfillment trading in a case where the evaluation value of any one user of the “user who causes the nonfulfillment trading” and the “user who has the disadvantage due to the nonfulfillment trading” in the nonfulfillment trading (the nonfulfillment trading) is higher than the evaluation value of the user in another nonfulfillment trading (“user who causes the other nonfulfillment trading” and “user who has the disadvantage due to the other nonfulfillment trading”). Therefore, it is possible to preferentially suppress the inconvenience to the partner by the user having a high evaluation value due to the nonfulfillment of the power trading, and it is possible to preferentially suppress the disadvantage of the user having a high evaluation value due to the nonfulfillment of the power trading.

On the other hand, the disadvantage to the user having a high evaluation value due to the nonfulfillment of the power trading may be preferentially suppressed. For example, in S13 and S15, the evaluation value of the user who has the disadvantage due to the nonfulfillment trading (user who can fulfill the power trading) is extracted from the evaluation value information of the agent information 36, and the alternative trading may be performed with respect to the power trading contracted by the user having the highest evaluation value.

In addition, it may be possible to preferentially suppress the inconvenience to the partner by the user having a high evaluation value due to the nonfulfillment of the power trading. For example, in S13 and S15, the evaluation value of the user who causes the nonfulfillment trading (user who has a cause that makes the fulfillment of the power trading difficult) is extracted from the evaluation value information of the agent information 36, and the alternative trading may be performed with respect to the power trading contracted by the user having the highest evaluation value.

The embodiment disclosed this time should be considered to be exemplary examples and not to be restrictive in all respects. The scope of the present disclosure is shown by the scope of claims rather than the description of the embodiment described above, and is intended to include all changes within the meaning and scope equivalent to the scope of claims.

What is claimed is:

1. A power trading system comprising:
a server configured to manage a power trading market in which power trading is directly performed between a supply side and a demand side of power;
an agent for a user who participates in the power trading market to perform a bid; and
an alternative power storage device managed by an operator who operates the power trading market, wherein:
the agent includes
a power trading plan creation unit configured to create a power trading plan for performing the power trading through the power trading market, and
a bid unit configured to perform a bid based on the power trading plan; and
the server includes
a contract unit configured to aggregate the bids and perform contract for the power trading, and
a trading alternative unit configured to, in a case where nonfulfillment trading occurs in which fulfillment of the contracted power trading is difficult, perform the power trading related to the nonfulfillment trading by using the alternative power storage device.

2. The power trading system according to claim 1, wherein:
the server further includes an evaluation value calculation unit configured to calculate an evaluation value of the user based on a fulfillment history of the user with respect to the contract; and
the evaluation value calculation unit is configured to calculate the evaluation value such that the evaluation value of the user who causes nonfulfillment deteriorates in a case where the contracted power trading is not fulfilled.

3. The power trading system according to claim 2, wherein the trading alternative unit is configured to perform the power trading related to the nonfulfillment trading of the user having a highest evaluation value among the users by using the alternative power storage device in a case where a plurality of pieces of the nonfulfillment trading occurs and there is competition for the power trading by using the alternative power storage device between the users.

4. The power trading system according to claim 1, wherein the alternative power storage device is a vehicle on which a power storage device is mounted.

5. The power trading system according to claim 1, wherein:
the power trading plan creation unit is configured to create the power trading plan of an electrified vehicle; and
the trading alternative unit is configured to predict occurrence of the nonfulfillment trading based on positional information of the electrified vehicle.

6. The power trading system according to claim 1, wherein the trading alternative unit is configured to determine that the nonfulfillment trading occurs in a case where the user reports the nonfulfillment trading.

7. The power trading system according to claim 1, wherein the trading alternative unit is configured to perform the power trading related to the nonfulfillment trading by discharging the alternative power storage device of which an SOC is equal to or larger than a predetermined value, and perform the power trading related to the nonfulfillment trading by charging the alternative power storage device of which the SOC is less than the predetermined value.
